(19) United States
(12) Patent Application Publication
(10) Pub. No.: US 2016/0269979 A1
(43) Pub. Date: Sep. 15, 2016

(54) METHOD AND APPARATUS FOR FAST COMMUNICATION OF INFORMATION DURING BLUETOOTH DISCOVERY PHASE

(71) Applicant: 650 Industries, Inc., Palo Alto, CA (US)

(72) Inventors: James Hiroaki Ide, San Jose, CA (US); Charles Duplain Cheever, Palo Alto, CA (US)

(21) Appl. No.: 15/043,891

(22) Filed: Feb. 15, 2016

Related U.S. Application Data
(60) Provisional application No. 62/131,945, filed on Mar. 12, 2015.

(51) Int. Cl. H04W 48/10; H04W 4/00; H04W 52/02; H04W 4/20

(52) U.S. Cl. CPC H04W 48/10; H04W 4/206; H04W 4/008; H04W 52/0219

(57) ABSTRACT

The present invention is directed to a system for sharing data between devices. In some embodiments, the system comprises one or more advertising devices in advertising mode transmitting advertising packets, the advertising packets comprising at least shared data and one or more scanning devices in scanning mode, scanning for advertising packets in order to establish a low power BLUETOOTH connection, wherein the one or more scanning devices performs a method comprising: receiving the advertising packets from the one or more advertising devices, inspecting the advertising packets to determine whether they contain a particular application marker, extracting the shared data from the advertising packets when the particular application marker exists and discarding the advertising packets prior to initiating a pairing with the one or more advertising devices.

### CROSS-REFERENCE TO RELATED APPLICATION

This application claims benefit of U.S. Provisional Patent Application No. 62/131,945 filed Mar. 12, 2015, which is hereby incorporated in its entirety.

### BACKGROUND OF THE INVENTION

1. Field of the Invention

Embodiments of the present invention generally relate to detecting proximity of a mobile device, and, more particularly towards a method and apparatus for fast communication of information during Bluetooth discovery phase.

2. Description of the Related Art

Modern Bluetooth technology facilitates data exchange between mobile devices such as mobile telephones, tablet computers, notebook computers and the like. Bluetooth Low Energy (BLE) devices often do not require pairing two devices in order to exchange information; however they do typically require some form of a connection to be established between the devices. Before devices can share or communicate information with each other, the devices must be connected together. The connection process involves each Bluetooth capable device broadcasting an advertisement packet if they are open to connecting with other devices. The advertisement packet contains proprietary information such as the operating system of the broadcasting device, installed applications, and information regarding the network address of the device. Another device wishing to exchange or communicate information with the broadcasting device scans for advertising packets broadcast by nearby devices and gives that list of information to the user. In order to establish a connection between the devices, a time and resource consuming data exchange takes place including reading a set of services and characteristics/values from a broadcasting device. Further, a device may be limited to establishing only a certain number of connections with other devices using BLE, thereby limiting the amount of devices data can be shared with. Therefore, before a user of the mobile devices can share information they desire to exchange, a series of technical and networking data is exchanged between the devices. Thus a significant amount of time elapses during the connection process before the user can identify nearby devices or share information, for example, electronic business cards, music files, digital photos, or the like, causing unwanted delay, user frustration and battery consumption.

Therefore, it is desirable that Bluetooth capable devices such as mobile telephones, tablets, laptops and the like be able to communicate data with each other in order to exchange information, enable user communications, or to authenticate other devices and users, in addition to many other uses, in a faster and more convenient way without relying on a device connection while avoiding excessively and unnecessarily consuming device resources.

### SUMMARY OF THE INVENTION

According to one embodiment, the present invention relates to a system to retrieve a user profile comprising: a first device that generates an adjusted advertisement packet containing shared data corresponding to a user of the first device, one or more devices that scan for the advertising packets, receive the packets and determine whether the shared data is relevant to the system; and discard the advertisement packet prior to initiating a Bluetooth connection.

Other and further embodiments of the present disclosure are described below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a system for fast communication of information with nearby mobile devices during Bluetooth discovery phase in accordance with exemplary embodiments of the present invention;

FIG. 2 illustrates a system for establishing the identity of nearby mobile device users without establishing a connection between the devices in accordance with exemplary embodiments of the present invention;

FIG. 3 is a block diagram of a packet adjuster in accordance with an exemplary embodiment of the present invention;

FIG. 4 is a detailed block diagram of a portion of the advertising packets in accordance with an exemplary embodiment of the present invention;

FIG. 5 is a block diagram of a profile manager in accordance with an exemplary embodiment of the present invention;

FIG. 6 is a block diagram depicting a computer system for implementing portions of the system illustrated in FIG. 1 in accordance with exemplary embodiments of the present invention;

FIG. 7 is a flowchart for a method of adjusting advertising packets in accordance with an exemplary embodiment of the present invention; and

FIG. 8 is a flowchart for a method for identifying users of nearby devices in accordance with an exemplary embodiment of the present invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention generally relate to a method and apparatus for fast communication of information via Bluetooth without establishing a device connection during the Bluetooth discovery phase. In one embodiment, several Bluetooth capable devices in the same vicinity broadcast advertising packets indicating that the devices support Bluetooth during a discovery phase. The advertising packets are modified to include information that the user of the mobile devices broadcasting the advertisement packet wish to share with other devices. Once the advertisement packet is broadcast, any device that is scanning for Bluetooth advertising packets will receive and inspect the advertising packet. Instead of going through the process of establishing a connection with a receiving device and a broadcasting device, the receiving device inspects the advertisement packet to determine whether shared information is located within, and if so, extracts the shared information. The receiving devices then discard the advertising packet, and do not continue with the connection process since the shared information has already been exchanged. In some embodiments, the shared information can facilitate the counting of nearby Bluetooth capable devices, polling or voting applications, or any usage requiring a small amount of data to be communicated with very low overhead. The shared information may contain a URL which links to an executable script, device instructions, binary data, textual data, polling or voting instructions, or the like. In some embodiments, the shared information is used to retrieve a profile from a profile database, generally located remotely from the device. The profile is then added to the receiving devices profile manager, and the user of the receiving device can view profile information of the user of the broadcasting device.

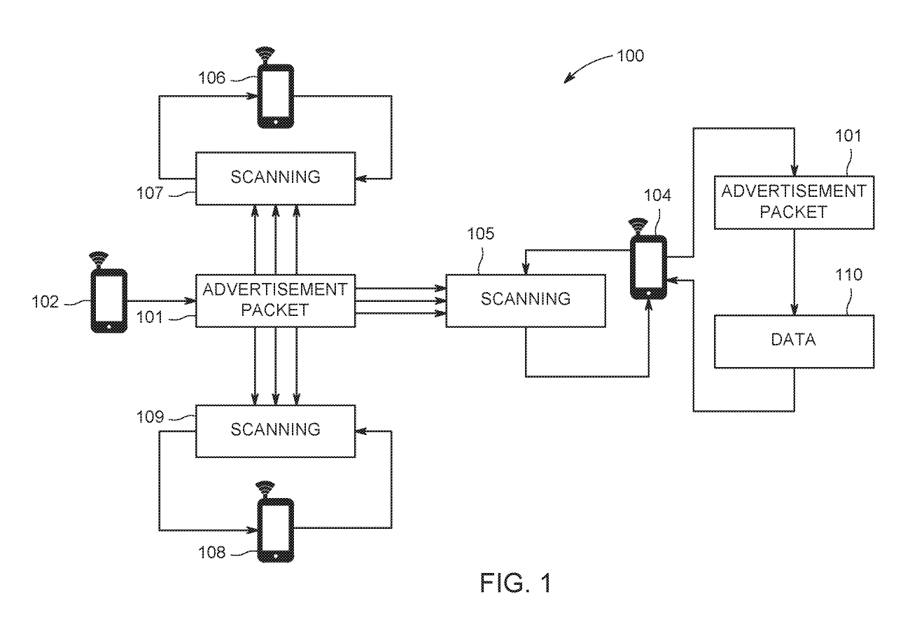

FIG. 1 illustrates a system for fast communication of information with nearby mobile devices using Bluetooth discovery phase in accordance with exemplary embodiments of the present invention.

Devices 102, 104, 106 and 108 are mobile devices capable of communicating information via a Bluetooth connection. The devices 102, 104, 106 and 108 are assumed, for the sake of the present invention, to be within Bluetooth communication range. In traditional circumstances, in order to exchange any information, the devices must be connected to each other. In the present invention, no connection is established before information is exchanged. During the discovery phase, device 102 broadcasts an advertisement packet 101 which is modified to include shared data when the device 102 is ready to be connected with another device. The device 104 scans using scanning mode 105 for advertising packets. In scan mode 105, each of the devices 104, 106 and 108 receives the advertisement packet 101.

Once the advertisement packet 101 is received, device 104 (for example) inspects the advertisement packet 101 to determine whether the packet 101 contains data 110 that the device 102 is sharing. In some instances, the data 110 is data that the user has chosen to share. In other instances, the data 110 is data that is selected by an operating system, or an application installed on the device 102, for sharing with other devices. After the data 110 is extracted from the packet, instead of continuing with a BLE connection, the advertisement packet 101 is discarded, discontinuing any further connection of the broadcasting device and the receiving device. The devices 106 and 108 can similarly extract data 110 from the advertisement packet 101. Thus, low-bandwidth, fast data transmission is achieved via Bluetooth, but without the time and resource consuming process of establishing BLE connections. Those of ordinary skill in the art will recognize that the data 110 may comprise any type of data 110, small in size, but used to communicate between applications installed on mobile devices, simple textual data, image data, or the like. The present invention does not limit what is stored in data 110. In some embodiments, the data 110 can comprise user identification/login information, uniform resource locators (URLs), networking addresses, user data, or the like. In other instances, the data 110 may contain instructions informing the receiving device, e.g., device 104, to broadcast its own advertisement packet 101 to send out data to other devices within Bluetooth range.

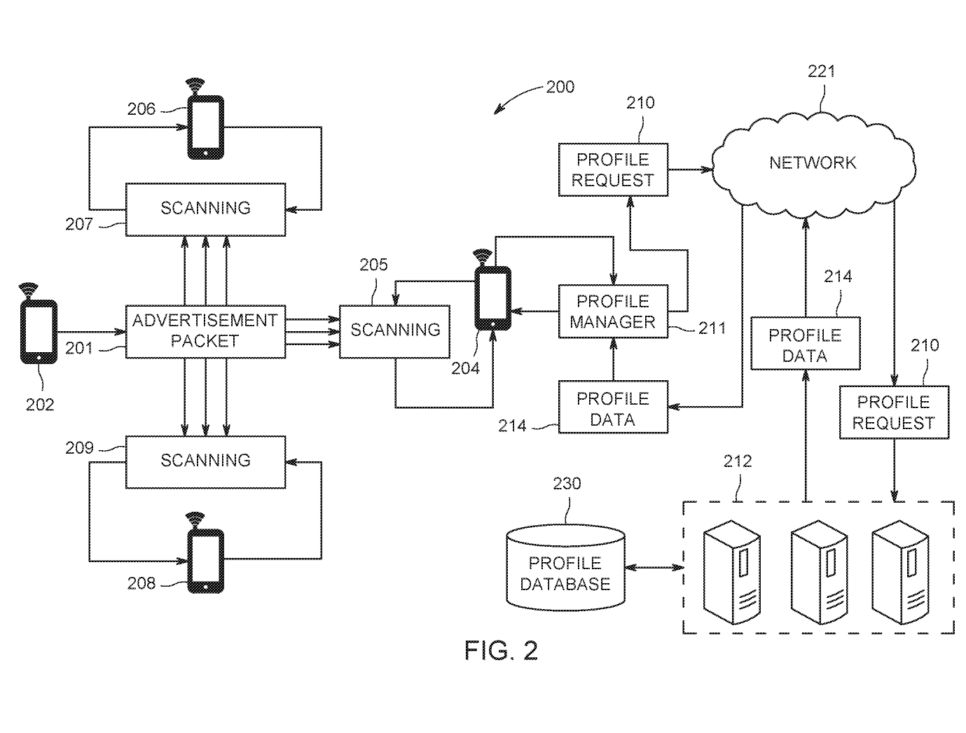

FIG. 2 illustrates a system 200 for establishing the identity of nearby mobile device users without establishing a connection between the devices in accordance with exemplary embodiments of the present invention.

The devices 202, 204, 206 and 208 are generally mobile devices such as mobile phones, tablets, laptop computers, and the like, each which has BLE capabilities. Specifically, the devices 202-208 have low-energy Bluetooth chips installed, or low-energy Bluetooth capabilities available through extensions such as dongles or the like. Each of the devices 202, 204, 206 and 208 has a profile stored thereon editable and accessible by an application such as the profile manager 211. The profile manager 211 controls modification and creation of a user's own personal profile as well as management of profiles the user has come in contact with. Those of ordinary skill in the art will recognize that while profile manager 211 is shown outside of the device 204, the profile manager 211 is generally an application executing on the device 204.

When the device 202 comes to be in the general vicinity of the other devices such as devices 204, 206 and 208, to the extent that Bluetooth packets reach the devices, it is desirable that, for example, a user profile of the user of device 202 be displayed and accessible on the devices 204, 206 and 208. In order to accomplish this, the Bluetooth functionality on all devices is enabled. While the device 202 has Bluetooth enabled and is in “advertising” mode, the device 202 broadcasts an advertisement packet 201, modified to include profile identifying information. In some embodiments, the profile identifying information includes a user ID, a MAC address associated with a profile on a remote server, a user's full name, or the like. While each device is in scanning mode, if device 202 is in range, the device receives the broadcasted advertisement packet 201. For example in FIG. 2, scanning 205 indicates that the device 204 is actively scanning for broadcasted advertising packets. Similarly, device 206 is associated with scanning 207 and device 208 is associated with scanning 209. Scanning 205, scanning 207 and scanning 209 are not objects which are communicatively coupled to the devices, but merely are virtual indicators that each respective device is in scan mode.

Device 204 is used as an illustrative example of the scan mode interaction with the advertising packets. The device 204 scans for packets and receives the advertisement packet 201. In normal operation, the device 204 would receive advertisement packet 201 and then initiate a pairing operation which requires several steps including authentication in order to connect the two devices. Instead, the advertisement packet 201 is inspected by the profile manager 211 and if the advertisement packet 201 contains an application marker that indicates it is associated with a particular type of data, e.g., identification data that profile manager 211 will recognize, the advertisement packet are discarded after the identification data is extracted. The two devices do not pass through to the stages of initiating a Bluetooth pairing because the data used to initiate a request, e.g., a profile request, has already been received by device 204.

Once the device 204 finds that the advertisement packet 201 includes the application marker, indicating that the advertisement packet 201 is intended for profile retrieval, the profile manager 211 extracts identification data from the advertisement packet 201 that contains identifying information for a profile of the user of device 202 in system 200.

The profile request 210 is transmitted across a network 221 to one or more servers 212 (collectively referred to as server 212). According to one embodiment, the servers 212 parse the profile request 210 to extract the profile identifying information and compare the information to existing information in associated profile databases 230. Once a match is determined based on the profile identifying information, the servers 212 return profile data 214 to the profile manager 211 via network 221. The profile manager 211 inserts the profile data 214 into its list of profiles of users and the user of device 204 now has access to the profile of the user of device 202.

According to some embodiments, the profile manager 211 indicates to the user of each device the location status of other users previously added to the profile manager 211. For instance, if a user moves out of Bluetooth connectivity range, the profile manager 211 may visually indicate this by, for example, placing the profile on a different list, greying out the profile, pushing the profile to the bottom of the list or the like. Since no Bluetooth pairing takes place, the lack of advertising packets may be used to determine the movement of device 202 out of the connectivity range with device 204. In some embodiments, the profile manager 211 may determine the distance of other users from the device 204 for example, by scanning for periods of time to determine if advertising packets associated with profiles within the profile manager 211 grow apart in broadcast time or are not received at all. In some embodiments, signal strength of the advertising device 202 can be used to order the profiles in the profile manager 211 according to proximity to scanning devices which receive the profile. The proximity data can be tracked for frequency, duration, timestamps of encounters with others and the like which can be used to as part of an algorithm to infer a relationship between people, or the strength of a social bond between people.

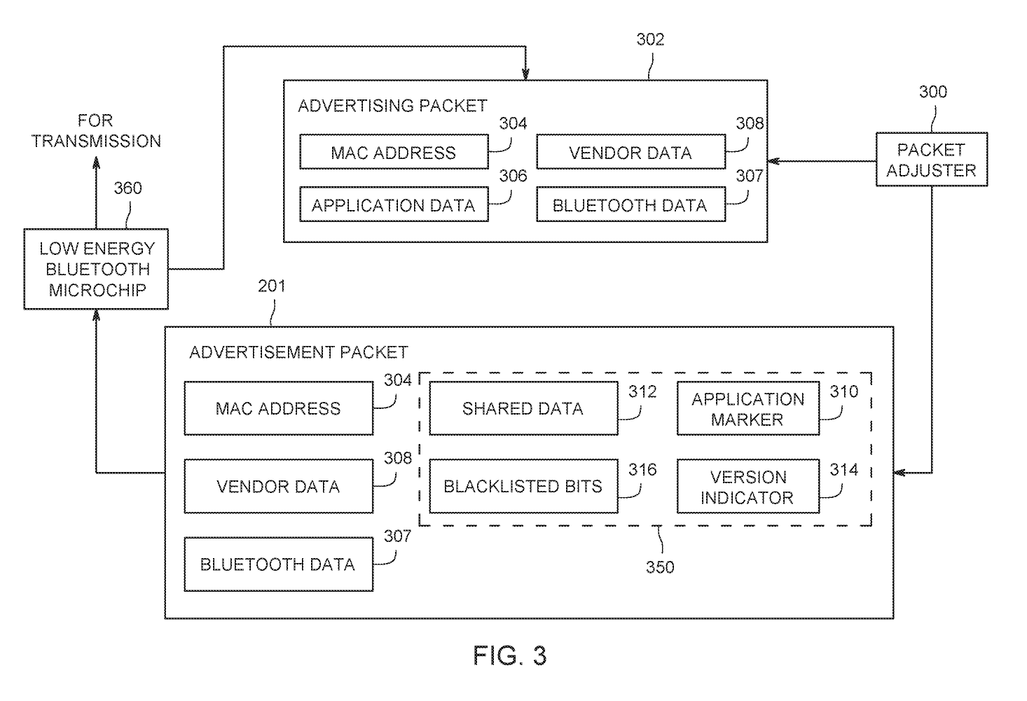

FIG. 3 is a block diagram of a packet adjuster 300 in accordance with an exemplary embodiment of the present invention. Those of ordinary skill in the art recognize that devices equipped with low energy Bluetooth microchip 360 can generate a standard advertisement packet 302. Generally, this advertisement packet is known to contain a media access control address 304 (MAC address 304), vendor data 308 and application data 306, along with other Bluetooth data 307 generally associated with Bluetooth advertising packets.

The MAC address 304 is a unique identifier for the particular network interface used by the device (e.g., device 202 in FIG. 2) broadcasting an initial advertisement packet 302. Vendor data 308 may differ from vendor to vendor—for example, APPLE inserts proprietary information in the vendor data 308 differently from ANDROID devices. Similarly, application data 306 differs from vendor to vendor, however it is known that APPLE encodes applications that are currently running on the device 202 using a Bloom filter that determine which bit is set in application data 306. Generally, the application data 306 comprises 128 bits of addressable data.

The packet adjuster 300 is generally an application or service installed and executing on each of the devices 202, 204, 206 and 208, as well as any other device with the profile manager installed and willing to participate in profile sharing via the system 200.

Using device 202 as an example, the underlying operating system allows a currently executing application on device 202 to specify a device name and one or more services that the application supports. IOS® employs the use of 128 bits in the advertisement packet referred to as “overload data” to advertise which services are supported by a peripheral, e.g., device 202. Since the device 202 contains possibly more than 128 applications and/or services, a Bloom filter is used to encode which services are supported by the peripheral in that 128 bit space. Each service identified by IOS® is assigned one bit from the 128 bits, and if the service is supported by the device 202, that particular bit is turned on (e.g., set to 1). Thus, by selecting one or more services it becomes possible to write a custom pattern of bits to the overload data. It is possible that two services are assigned the same bit, therefore false positives can occur where a receiving device (e.g., device 208) believes device 202 supports service A, while instead, device 202 supports service B which shares the service bit in the 128 bits.

Accordingly, by advertising a support for one or more particular service, any permutation of bits in the 128 bits of the advertisement packet 302 may be set in order to encode the shared data in the overload portion, or the “application data” 306.

Once the low energy Bluetooth microchip 360 of, for example, device 202, generates the advertisement packet 302 and readies the packet for transmission, the packet adjuster 300 modifies the advertisement packet 302 by modifying particular portions (hereinafter referred to as modified portion 350) of the advertisement packet 302 transforming the advertisement packet 302 into the advertisement packet 201 to include information to be shared in the modified portion 350. The space allocated to the application data 306, is 128 bits in length in some embodiments. The bits used to store the application data 306 are modified by the packet adjuster 300 to include an application marker 310, shared data 312312, version indicator 314 and blacklisted bits 316. In this embodiment, the mac address 304, vendor data 308 and Bluetooth data 307 are unmodified. Thus the modified portion comprises shared data 312, application marker 310, blacklisted bits 316 and version indicator 314.

The application marker 310 is generally 4 to 5 bits in length and indicates to a scanning device that shared data 312 is contained therein. In some embodiments, the application marker 310 indicates to a profile manager that the advertisement packet is to be used for profile retrieval purposes, and user identification data is contained therein. The shared data 312 is generally from 20 bits to 100 bits, though the size can be customized according to the application. In other embodiments, the shared data 312 can contain user login information, user preferences, URLs to scripts for execution, profile identification data, or the like. In one embodiment, shared data 312 contains information which identifies the profile of the user of device 202. According to one embodiment, the shared data 312 contains a presence token which uniquely identifies a device and may be a key to any arbitrary amount of information (e.g., photos, names, email addresses, personal preferences, or the like) stored locally within a device or remotely in the cloud. According to another embodiment, a Bluetooth printer that is discoverable using the techniques described in the present application is envisioned, which advertises the IP address of the printer within the shared data 312, enabling simpler connections to the printer from mobile phones or tablets located on different local area networks than the printer. The version indicator 314 indicates which version of an application, e.g., the profile manager application, is currently being used by the device 202 which broadcasts the advertising packets 201. In some embodiments, the version indicator 314 is two bits in length, and is replicated in some instances four times. Finally, the blacklisted bits 316 are bits which are unmodified by the packet adjuster 300, and are generally 24 bits in length. Those of ordinary skill in the art will recognize that modifying the application data 306 means modifying the data in the bits used to store the application data 306.

According to another embodiment of the present invention, in an ANDROID device that has lower level access to the Bluetooth stack, the mac address 304 is also available for modification. In this embodiment, shared data is inserted into the bits used for the mac address 304. Because the device 202 is not trying to pair with device 204, the device 204 is not concerned with how to locate the device 202 on a network allowing the MAC address 304 to be adjustable. As described above, other data may also be included in the space occupied by the MAC address 304 if supported by the device 202. The profile manager 211 can identify, based on vendor data 308, which type of device is broadcasting the advertisement packet 201, and can look for the data either in the space for the mac address 304 or the space for the application data 306. In this manner, ANDROID and APPLE (and other platforms) devices will be able to receive and inspect packets from any type of device and retrieve the profile of the user regardless of the platform of their device. In some embodiments, ANDROID devices with access to the Bluetooth stack can inspect the received advertisement packet 201 to determine whether particular bit patterns are set as described above, allowing the present application to function with a mixture of different types of devices.

Finally, the advertisement packet 201 (as modified by the packet adjuster 300) is sent to the low energy Bluetooth microchip 360 for broadcasting to all nearby Bluetooth enabled devices such as devices 204, 206 and 208. In exemplary embodiments, the advertisement packet 302 is merely a representation of a generic advertisement packet, while the advertisement packet 201 represents a “modified” packet containing at least the shared data 312. The shared data 312 is represented as a pattern of bits set by selecting a particular set of services as being offered by the device 202.

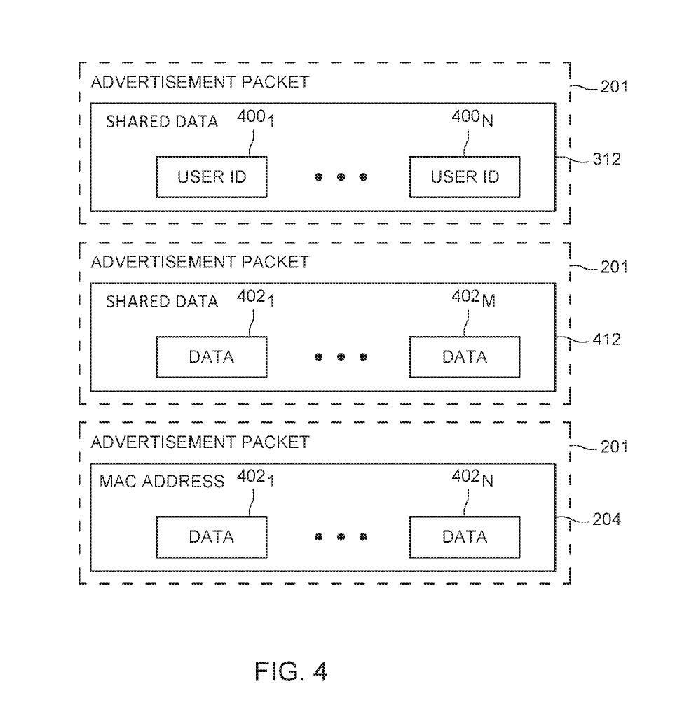

FIG. 4 is a detailed block diagram of a portion of the advertising packets in accordance with an exemplary embodiment of the present invention.

In one embodiment, the advertisement packet 201 includes shared data 312. In this embodiment, the shared data 312 comprises user identification data. The user identification data is a user ID such as a login name associated with the profile manager 211 and the system 200. For example, the login is stored as a user ID 400₁ in the shared data 312. When the device 204 scans and observes the broadcasted advertisement packet 201, the device 204 extracts the user ID 400₁ and packages the user ID 400₁ into the profile request 210 to receive the profile data 214. According to some embodiments, the user ID 400₁ is 20 bits in length, and is repeated multiple times. For example, in FIG. 3, the user Identification data is stored N times: user ID 400₁ to 400_{N}. In one embodiment, N=5, where a total of 100 bits are used by the user ID in the shared data 312. The redundancy proposed makes it less likely that another application on device 202 (or any device/application) which encodes data within an advertisement packet collide with the shared data 312. Those of ordinary skill in the art will recognize that may forms of redundancy may be used for error-correction not limited to the redundancy described above and other markers such as the application marker 310, the version indictor 314 and other bits can also be redundant for error-checking.

In another embodiment, the advertisement packet 201 includes contains data 402₁ to 402_{M} instead of user IDs. The data is information that can, in one embodiment, be used to identify a user of a device, for example: user interests, a user's given name, or the like. The data may also comprise a URL from which executable instructions can be retrieved, digital image or textual data, or the like. Those of ordinary skill in the art will recognize that data is not limited by the present invention, and can contain multiple data points used, for example, to uniquely identify a user of device 202 or a profile of such a user. Each discrete set of data 402₁ to 402_{M} may be identical, or may differ.

In yet another embodiment, the advertisement packet 201 can be modified such that the memory bits where the MAC ADDRESS 304 is located are changed to include data 402₁ to 402_{N}. Though not shown, the MAC ADDRESS 304 can also be modified to contain profile information, user ID/login information, URL information, device information, or the like.

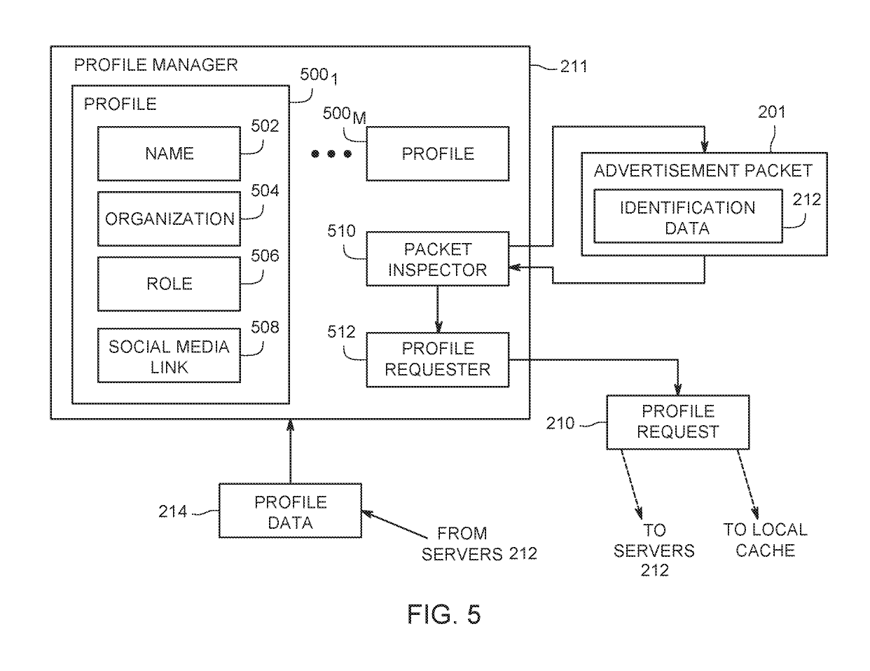

FIG. 5 is a block diagram of a profile manager 211 in accordance with an exemplary embodiment of the present invention. While the same profile manager is executing on each of the devices 202, 204, 206 and 208, for FIG. 5, the profile manager 211 is associated with the device 204 which scans and inspects advertisement packet 201. The profile manager 211 manages profiles 500₁ to 500_{M}, each corresponding to a profile associated with a user of a nearby device such as device 202, 206 and 208, in addition to profiles associated with users of devices that are no longer in Bluetooth range. The profile manager 211 allows the user of device 204 to view each of the profiles 500₁ to 500_{M}, communicate with users of the profile, research the users of each profile, obtain related profile links, obtain the user's contact information, and the like. In some embodiments, each of the profiles 500₁ to 500_{M} comprise at least a name 502, an organization 504, a role 506 and a social media link 508 through which a user's social media profiles can be accessed.

Additionally, the profile manager 211 comprises a packet inspector 510 and a profile requester 512. The packet inspector 510 is invoked while scanning for advertising packets. Once an advertisement packet is received, e.g., advertisement packet 201, the packet is inspected to determine whether application marker 310 exists within the packet, and whether the application marker 310 and the version indicator 314 are set to a correct value, where a correct value is one where the profile manager 211 determines that the bits were generated or modified by the packet adjuster 300 in service of the system 200. The version indicator 314 is inspected to determine whether the version of profile manager 211 is up-to-date with what is indicated in the version indicator 314.

The profile requester 512 extracts the shared data 312 if the application marker 310 is set and the version information is correct, and packages the shared data 312 extracted from the advertisement packet 201 into a profile request 210. As shown in FIG. 2, the profile request 210 is forwarded to local cache or the servers 212 to obtain profile data 214 corresponding to the shared data 312. The profile manager 211 then extracts the profile information from profile data 214 to store as a profile on the device 204.

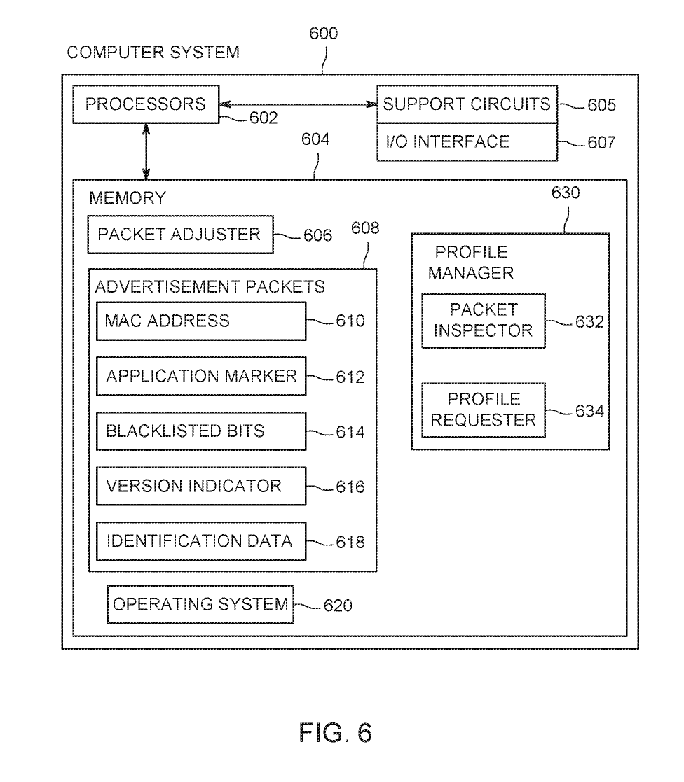

FIG. 6 is a block diagram depicting a computer system 600 for implementing portions of the system illustrated in FIGS. 1 and 2 in accordance with exemplary embodiments of the present invention. The computer system 600 includes processors 602, various support circuits 605, and memory 604. The processors 602 may include one or more microprocessors known in the art. The support circuits 605 for the processor 602 include conventional cache, power supplies, clock circuits, data registers, I/O interface 607, and the like. The I/O interface 607 may be directly coupled to the memory 604 or coupled through the support circuits 605. The I/O interface 607 may also be configured for communication with input devices and/or output devices such as network devices, various storage devices, mouse, keyboard, display, video and audio sensors and the like.

The memory 604, or computer readable medium, stores non-transient processor-executable instructions and/or data that may be executed by and/or used by the processors 602. These processor-executable instructions may comprise firmware, software, and the like, or some combination thereof. Modules having processor-executable instructions that are stored in the memory 604 comprise a packet adjuster 606 and a profile manager 630. The profile manager 530 further comprises a packet inspector 632 and a profile requester 634. The memory 604 also contains advertising packets 608, which further comprise at least a mac address 610, application marker 612, blacklisted bits 614, version indicator 616 and identification data 618.

The computer system 600 may be programmed with one or more operating systems 520, which may include OS/2, Linux, SOLARIS, UNIX, HPUX, AIX, WINDOWS, IOS, and ANDROID among other known platforms. The memory 604 may include one or more of the following: random access memory, read only memory, magneto-resistive read/write memory, optical read/write memory, cache memory, magnetic read/write memory, and the like, as well as signal-bearing media as described below.

Those skilled in the art will appreciate that computer system 600 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 600 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 600 may be transmitted to computer system 600 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

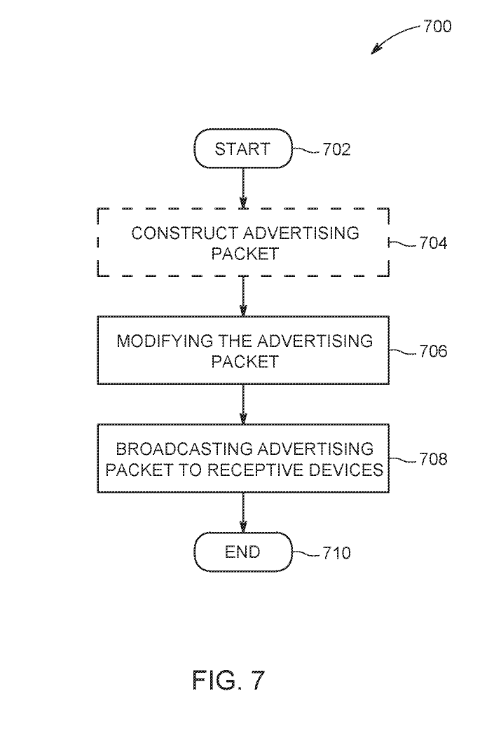

FIG. 7 is a flowchart for a method 700 of adjusting advertising packets in accordance with an exemplary embodiment of the present invention.

The method 700 is implemented as the packet adjuster 606 and executed on computer system 600 by at least a portion of the processors 602.

The method begins at step 702 and proceeds to step 704. At step 704, the packet adjuster 606 constructs an advertising packet as described above by selecting one or more services so that the underlying operating system, e.g. iOS® sets, through the use of a bloom filter, a particular pattern of bits in the advertisement packet recognizable by a profile manager on another device destined for broadcasting to other Bluetooth devices for BLE connection purposes. However, a BLE connection will not be established thus saving battery resources and time in sharing the data.

In some embodiments, if the underlying operating system of the device is ANDROID and the device has access to the Bluetooth stack, at step 706, shared data is inserted into the advertising packet directly. The shared data may be any data shared by a user or device that can be transmitted using low bandwidth methods described herein, such as image or textual data, binary data, URLs or the like, or in some instances, user identification data such as a login for system 200, or profile related data that can be used to identify a unique profile. In some embodiments, the shared data is located in the portion of memory where the advertisement packet contains application information such as which services are available on the mobile device broadcasting the advertising packet. In this embodiment, the shared data is stored multiple times for redundancy and error checking purposes. In other embodiments, the shared data is inserted into the portion of memory where the advertisement packet contains the MAC address for the device broadcasting the advertising packet. In some instances, for devices unable to read the data stored in the shared data location, the MAC address can be parsed from the advertisement packet and transmitted to a remote server, where the MAC address is associated with a profile. A receiving device can then determine the identity of the user of the broadcasting device via the MAC address. The shared data also includes at least an application marker, a version indicator and blacklisted bits which are unchanged.

At step 708, the advertisement packet is submitted to the low-power Bluetooth chip of a device for broadcasting to receptive devices. The method terminates at step 710.

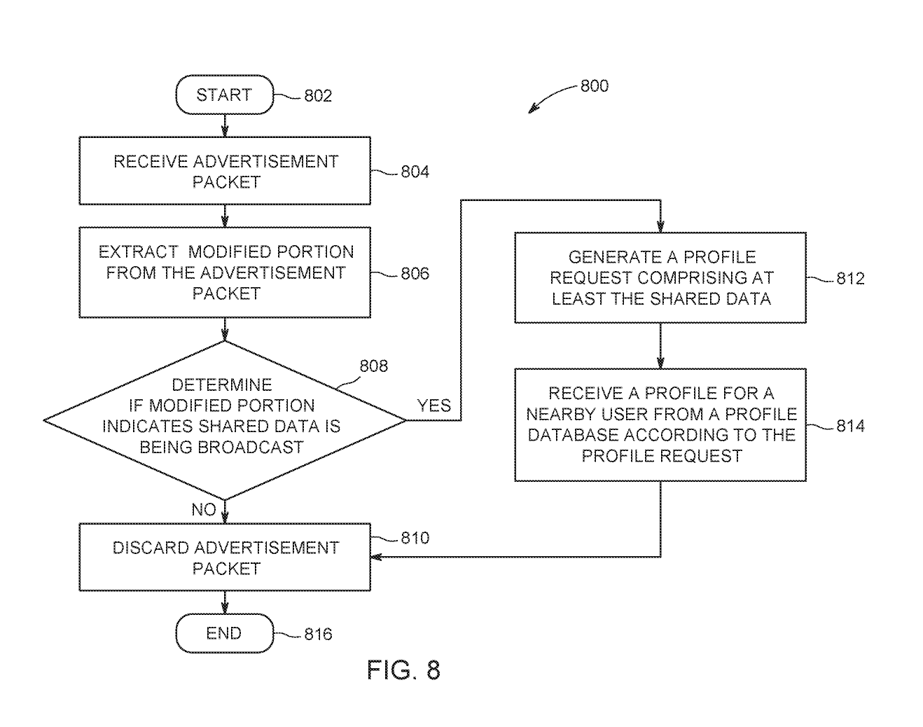

FIG. 8 is a flowchart for a method 800 for receiving shared data in accordance with an exemplary embodiment of the present invention.

The method 800 is implemented, in one embodiment, as the profile manager 630 and executed on computer system 600 by at least a portion of the processors 602.

The method begins at step 802 and proceeds to step 804. A step 804, a device (e.g., device 204) receives a Bluetooth advertisement packet while in a “scanning” mode. At step 806, the packet inspector 632 extracts the shared data from the advertisement packet in order to inspect the data contained therein. The packet inspector 632 begins looking at the bytes designated to be the application data, i.e., the data indicating which applications are available on the device that broadcasted the advertising packet. However, the profile manager 211 looks to determine if this advertisement packet originated from a device with a packet adjuster installed therein. In some embodiments, the device executing method 800 may not be looking for profile data, but is searching for other types of shared data, data to execute, data to perform voting or polling, or the like. Various other uses are contemplated besides sharing data for profile retrieval purposes.

The packet inspector 632 determines if the shared data is present on the device at step 808. This can be determined in several ways. According to one embodiment, the packet inspector 632 first looks for the application marker indicating that the device 202 is broadcasting shared data. If the application marker flag or bits are set to a particular value, the method 800 determines this packet originated from a device broadcasting shared data as a part of system 100 and the method proceeds to step 812. If no shared data is found, or the application marker is not set to the particular value, then the method proceeds to step 810, where the advertisement packet is discarded.

At optional step 812, if the shared data is profile related data the profile requester 634 generates a profile request comprising at least the identification data associated with the user of the device broadcasting the advertising packet. The profile request is then transmitted to a profile database, and the profile requester 634 receives profile data for the nearby user (of the device originating the advertising packet) according to the profile request at step 814 and stores the profile data as a profile in profile manager 211. In some embodiments, instead of reading the shared data, if the device has access to the Bluetooth stack, the advertisement packet is inspected for the MAC address. The MAC address is submitted in the profile request sent to a remote server where the MAC address is matched with a profile. The profile is then submitted to the receiving device to store as a profile in the profile manager 211.

The receiving device, e.g., device 204, afterwards discards the advertisement packets at step 810—in other words, the device 204 discontinues the Bluetooth pairing process, because the data needed to be shared to, for example, retrieve a user profile had already been shared via the advertisement packet. Thus, the method terminates at step 816.

While the foregoing is directed to embodiments of the present invention, other and further embodiments of the invention may be devised without departing from the basic scope thereof, and the scope thereof is determined by the claims that follow.

1. A method for fast communication of information comprising:
modifying an advertisement packet by inserting shared data into a portion of the advertising packet; and
broadcasting, from a first mobile device, the advertising packet without continuing with a device connection process between the first mobile device and one or more scanning mobile devices.

2. The method of claim 1, wherein the shared data is information that a user of the first mobile device intends to share with users of the one or more scanning mobile devices.

3. The method of claim 2, wherein the shared data is used by the scanning mobile devices to obtain further information from a remote service.

4. The method of claim 3, wherein the shared data comprises identifying information and the further information comprises information obtained via the identifying information.

5. The method of claim 3, wherein the shared data comprises one or more of textual data, image data, identification information, uniform resource locators, network addresses, instructions for the one or more scanning mobile devices and user data.

6. The method of claim 1, wherein the advertising packet comprises at least vendor data, the vendor data comprising information related to a vendor of the first mobile device and application markers indicating supported applications of the first mobile device.

7. The method of claim 6, further comprising:
overloading the vendor data by writing over the vendor data with a customized pattern of one or more application markers.

8. The method of claim 7, wherein the application markers are contained in a bloom filter.

9. The method of claim 8, further comprising:
setting a particular pattern of bits in the bloom filter to indicate to the one or more scanning mobile devices that the advertising packet contains the shared data.

10. The method of claim 8, wherein the shared data is stored multiple times in the advertising packet for redundancy and to avoid false positives in the bloom filter.

11. The method of claim 7, further comprising:
receiving a second advertising packet comprising second shared data from a second mobile device;
inspecting the advertising packet to determine whether it contains a particular application marker;
extracting the second shared data from the advertising packet when the application marker exists; and
discarding the advertising packet prior to initiating a pairing between the first mobile device and the second mobile device.

12. The method of claim 11, further comprising generating a profile request comprising at least the second shared data.

13. The method of claim 12, further comprising:
receiving a profile for a user from a profile database according to the profile request.

14. The method of claim 13, further comprising:
inferring relationship information between the user of a device making the profile request and the user of the device associated with the profile by tracking frequency, duration and timestamp of generating the profile request.

15. The method of claim 10, wherein the shared data comprises one or more of a uniform resource locator (URL), textual data, binary data, or network location information.

16. The method of claim 15, wherein the shared data is network location information for a BLUETOOTH Low Energy (BLE) enabled peripheral device.

17. The method of claim 1, wherein the first mobile device and the one or more scanning mobile devices have BLUETOOTH enabled.

18. The method of claim 1, wherein the first mobile device and the one or more scanning mobile devices support BLUETOOTH Low Energy (BLE) connections.

19. The method of claim 1, wherein the shared data is shared between devices while a BLUETOOTH pairing operation between any devices sharing data is never completed.

20. A system for sharing data between devices comprising:
one or more advertising devices in advertising mode transmitting advertising packets, the advertising packets comprising at least shared data; and
one or more scanning devices in scanning mode, scanning for advertising packets in order to establish a low power BLUETOOTH connection, wherein the one or more scanning devices performs a method comprising:
receiving the advertising packets from the one or more advertising devices;
inspecting the advertising packets to determine whether they contain a particular application marker;
extracting the shared data from the advertising packets when the particular application marker exists; and
discarding the advertising packets prior to initiating a pairing with the one or more advertising devices.
